(19) United States
(12) Patent Application Publication
(10) Pub. No.: US 2015/0336177 A1
(43) Pub. Date: Nov. 26, 2015

(54) DIAMOND TIP CUTTING TOOL

(71) Applicants: Thomas A. Bickford, Sidney, OH (US); J. Randall Eicher, Bellefontaine, OH (US)

(72) Inventors: Thomas A. Bickford, Sidney, OH (US); J. Randall Eicher, Bellefontaine, OH (US)

(73) Assignee: Honda Motor Co., Ltd., Tokyo (JP)

(21) Appl. No.: 14/285,972

(22) Filed: May 23, 2014

(51) Int. Cl. B23B 27/16

(52) U.S. Cl. CPC B23B 27/1681; B23B 2200/3627; B23B 2205/12; B23B 2226/315; B23B 2260/146

(57) ABSTRACT

A diamond tip cutting tool adapted to be positioned in a cutter includes a polycrystalline diamond (“PCD”) chip and a cartridge defining an opening. The opening is adapted to receive the PCD chip. A wedge clamp is removably coupled to the cutter to secure the PCD chip in the opening.

### BACKGROUND

The subject matter disclosed herein relates to cutting tools and, more particularly, to cutting inserts for use in milling tools.

Known cutting tool inserts that are removably coupled to a cutter for milling aluminum include a carbide body and a diamond chip that is coupled to the carbide body by brazing. When the diamond chip is worn, the cutting tool insert must be returned to its supplier for reconditioning. Typically, the supplier removes the worn diamond chip from the carbide body, positions a shim, re-brazes the diamond chip to the carbide body, and grinds the diamond chip. However, the quality of the diamond chip may deteriorate over multiple brazing processes applied to the chip.

Further, at least some known cutting tool inserts include a chip breaker that breaks up aluminum scraps to prevent long strands of aluminum from forming during the milling process. Commonly known features of such chip breakers may include a scored surface of grooves on the diamond chip. However, the grooves may be clogged by the aluminum scraps, which lends to reduced efficacy or inoperability of the chip breaker over time.

Still further, at least some known cutting tool inserts have a defined insert geometry, e.g., the cutter has a positive insert geometry, a neutral insert geometry, or a negative insert geometry. The insert geometry is an angle at which a cutting tool insert interacts with a workpiece being milled. Typically, known cutting tool inserts are designed for a particular insert geometry and thus are not versatile in providing a variety of insert geometries.

In view of the foregoing, an improved cutting tool insert is desired. This disclosure is intended to address the above-noted problems and to provide related advantages.

### SUMMARY

In one aspect, a diamond tip cutting tool adapted to be positioned in a cutter is provided. The diamond tip cutting tool includes a polycrystalline diamond (“PCD”) chip and a cartridge defining an opening. The opening is adapted to receive the PCD chip. A wedge clamp is removably coupled to the cutter to secure the PCD chip in the opening.

In another aspect, a reusable diamond tip cutting tool adapted to be positioned in a cutter is provided. The reusable diamond tip cutting tool includes a polycrystalline diamond (“PCD”) chip and a cartridge defining an opening adapted to receive the PCD chip. The opening is formed in an outer edge of the cartridge and complementary in shape to the PCD chip. A wedge clamp is removably coupled to the cutter adjacent to the opening to overlap a portion of the opening. The wedge clamp removably secures the PCD chip in the opening and removably secures the cartridge to the cutter.

In yet another aspect, a method for changing an orientation of a polycrystalline diamond (“PCD”) chip of a reusable diamond tip cutting tool includes positioning the PCD chip in a first orientation in an opening defined by a cartridge to expose a first cutting surface of the PCD chip. A wedge clamp is removably coupled to a cutter to overlap a portion of the PCD chip to secure the PCD chip in the opening for cutting. The wedge clamp is at least partially removed from the cutter and the PCD chip is repositioned in the opening in a second orientation different from the first orientation to expose a second cutting surface on the PCD chip. The wedge clamp is removably coupled to the cutter to overlap a portion of the PCD chip to secure the PCD chip in the opening for cutting.

### BRIEF DESCRIPTION OF THE DRAWINGS

FIG. 1 is a perspective view of an exemplary diamond tip cutting tool according to one embodiment described herein;

FIG. 2 is an exploded view of the diamond tip cutting tool shown in FIG. 1;

FIG. 3 is a bottom view of the diamond tip cutting tool shown in FIG. 1;

FIG. 4 is a top view of the diamond tip cutting tool shown in FIG. 1;

FIG. 5 is a perspective view of another exemplary diamond tip cutting tool according to one embodiment described herein;

FIG. 6 is a front view of the diamond tip cutting tool shown in FIG. 5;

FIG. 7 is a top view of the diamond tip cutting tool shown in FIG. 5;

FIG. 8 is a plan view of a cutter including a plurality of diamond tip cutting tools as shown in FIG. 5 positioned within a corresponding recess defined in the cutter and removably coupled to the cutter;

FIG. 9 is a portion of the plan view of the cutter shown in FIG. 8;

FIG. 10 is a side view of the cutter shown in FIG. 8; and

FIG. 11 illustrates an exemplary method for changing an orientation of a polycrystalline diamond (“PCD”) chip of a diamond tip cutting tool according to certain embodiments described herein.

Other aspects and advantages of certain embodiments will become apparent upon consideration of the following detailed description, wherein similar structures have similar reference numerals.

### DETAILED DESCRIPTION

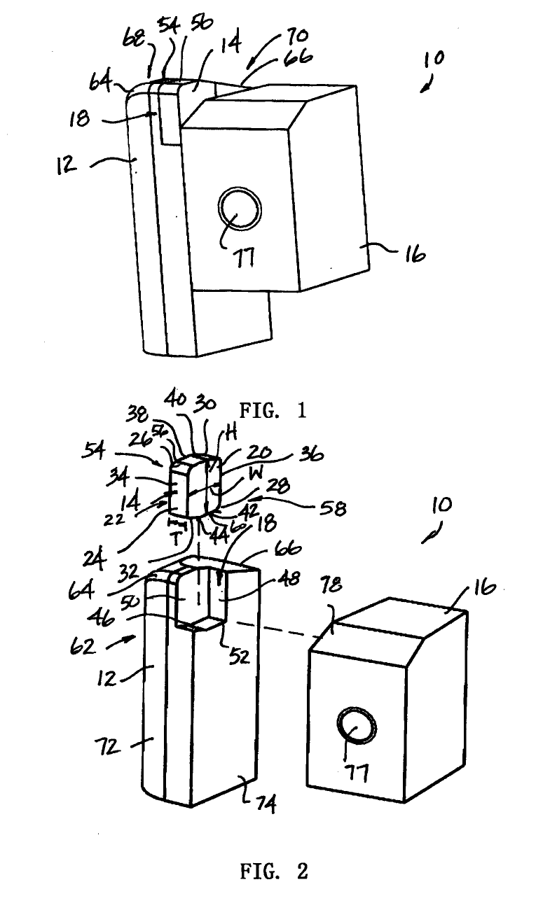

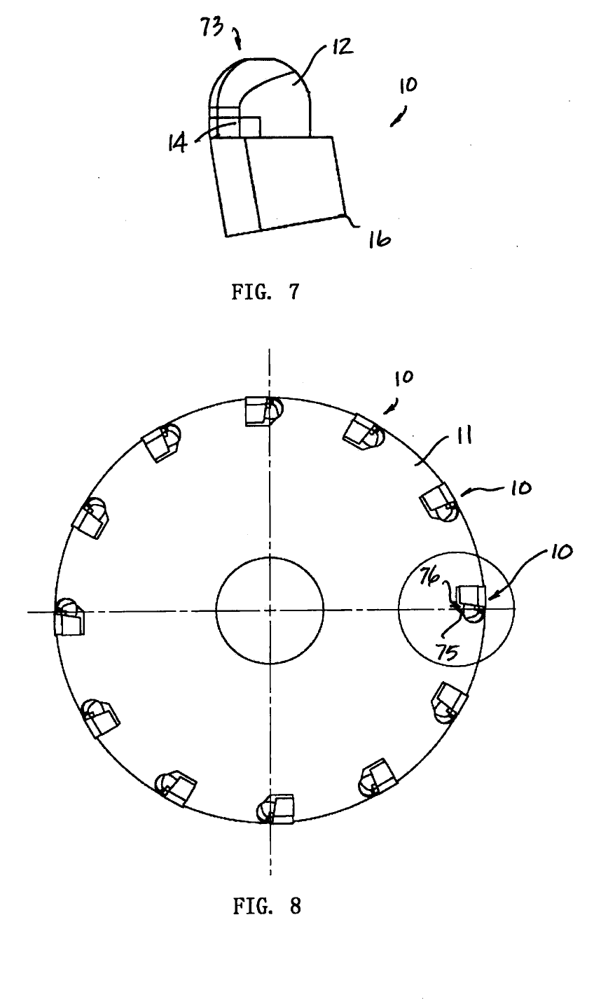

FIGS. 1-10 show exemplary embodiments of a diamond tip cutting tool (hereinafter referred to as “cutting tool”) 10. The cutting tool 10 is configured to be positioned in a suitable machining assembly, e.g., a cutter 11, such as shown in FIGS. 8-10, for milling an aluminum workpiece and/or other metallic or non-metallic materials. The cutting tool 10 includes a suitable cartridge, such as a carbide cartridge 12, a polycrystalline diamond (hereinafter referred to as “PCD”) chip 14, and a wedge clamp 16. The carbide cartridge 12 defines an opening 18 that is adapted to removably receive the PCD chip 14. In a particular embodiment, the opening 18 is formed in an outer edge of the carbide cartridge 12 and is complementary in shape to a plurality of different PCD chips 14. When assembled, the wedge clamp 16 is removably coupled to the cutter 11 in a manner that removably secures the PCD chip 14 within the opening 18 of the carbide cartridge 12 and secures the carbide cartridge 12 to the cutter 11. It is contemplated that the cutting tool 10 described herein provides for a reusable tool that may include improved chip breaker features, a plurality of replaceable wedge clamps 16 each having a predefined clamp angle to provide one of a variety of cutting tool insert geometries (e.g., a positive insert geometry, a negative insert geometry, or a neutral insert geometry), and/or additional benefits as described below.

Referring further to FIGS. 1-7, the cutting tool 10 is configured to receive the PCD chip 14 at the opening 18 of the carbide cartridge 12. In particular, the PCD chip 14 is a solid body that is generally rectangular-shaped, such as square-shaped. In some embodiments, the PCD chip 14 is formed from a solid carbide insert having a diamond coating that renders the PCD chip 14 suitable for carbon or aluminum milling. Referring to FIGS. 2, 5, and 6, for example, in the particular embodiments, the PCD chip 14 is generally slab-like with a first flat face 20 and an opposing second flat face 22 (not shown). Each of the first flat face 20 and the second flat face 22 is generally defined by a height H and a width W. In one embodiment, initially, prior to wear during milling, the first and second flat faces 20, 22 have the same or similar dimensions for the height H and the width W. Understandably, the height H and the width W of one or both flat faces 20, 22 decreases throughout a lifetime of the PCD chip 14, because during milling operations, the PCD chip 14 frictionally contacts and cuts the workpiece. In some embodiments, the height H and the corresponding width W on the first and second flat faces 20, 22 are initially equal, to define a generally square-shaped PCD chip 14.

As further shown in FIGS. 2 and 6, the first and second flat faces 20, 22 are spaced apart by a sidewall 24 extending therebetween and defining a thickness T of the solid PCD chip 14. The sidewall 24 defines a variety of physical features, including one or more flat sidewalls, rounded corners, and angular or beveled corners. In the particular embodiment shown in FIG. 2, the sidewall 24 defines a first rounded corner 26 and an opposing second rounded corner 28, and a first beveled corner 30 and an opposing second beveled corner 32. The sidewall 24 further includes a first flat sidewall 34 extending between the first rounded corner 26 and the second beveled corner 32, and an opposing second flat sidewall 36 extending between the first beveled corner 30 and the second rounded corner 28. Further, the sidewall 24 includes a first ramped sidewall 38 having a first apex 40 and extending between the first rounded corner 26 and the first beveled corner 30, and an opposing second ramped sidewall 42 having a second apex 42 and extending between the second rounded corner 28 and the second beveled corner 32. The thickness T of the PCD chip 14 may initially be uniform throughout the PCD chip 14 and subsequently decrease throughout the lifetime of the PCD chip 14 due to wearing or removal of the PCD chip 14.

In certain embodiments, other suitable cutting chips may be contemplated and retained by the cutting tool 10, for example, chips or inserts having other shapes, sizes, and/or orifices or grooves provided thereon, and other conventional chips or inserts having appropriate dimensions and specifications for machining a workpiece as desired. Other specifications for selecting chips or inserts may include, for example, hardness, toughness, antifriction, shock resistance, temperature resistance, and/or additional characteristics relevant to machining applications.

Still referring to FIG. 2, the PCD chip 14 defines a plurality of seating surfaces that are adapted to abut or otherwise engage a portion of the opening 18, whereby the seating surfaces all simultaneously or alternately engage the opening 18 during operation. Such seating surfaces can include any combination of the first and second flat faces 20, 22 and any portion of the sidewall 24 described above. In particular, the interaction between the seating surface and the opening 18 provides for a stable and securely engaged PCD chip 14 when seated or positioned within the opening 18. It is contemplated that more than one seating surface is defined by the PCD chip 14 to permit a variety of orientations of the PCD chip 14 within the opening 18. For instance, in FIG. 2, the seating surface may include the second ramped sidewall 42 having the second apex 44. In operation, the geometry of the second ramped sidewall 42 and the second apex 44 abuts a ramped wall 46 partially defining the opening 18 that provides similar, corresponding dimensions. The seating surface of the PCD chip 14 may further include the second flat sidewall 36, which is adapted to abut a straight wall 48 partially defining the opening 18. Still, the seating surface may include the second flat face 22 (not shown), which abuts a flat wall 50 partially defining the opening 18 of the carbide cartridge 12. The seating surface may further include the second rounded corner 28 of the PCD chip 14, which abuts or is adjacent to a corner surface 52 of the opening 18. It is noted that FIG. 2 illustrates an exploded view for one of several possible positions for the PCD chip 14 to be seated in the opening 18. As such, any combination of the first and second flat faces 20, 22, the first and second rounded corners 26, 28, the first and second beveled corners 30, 32, the first and second flat sidewalls 34, 36, the first and second ramped sidewalls 38, 42, and the first and second apexes 40, 44, as described above, may define a seating surface appropriate for the desired orientation of the PCD chip 14. It is contemplated that the opening 18 is complementary in shape with one or more of the plurality of seating surfaces and provides additional support to the PCD chip 14 even during wear of the PCD chip 14 that renders changes in the physical features thereof. Similarly, the PCD chip 14 includes a plurality of seating surfaces that are complementary in shape with the opening 18.

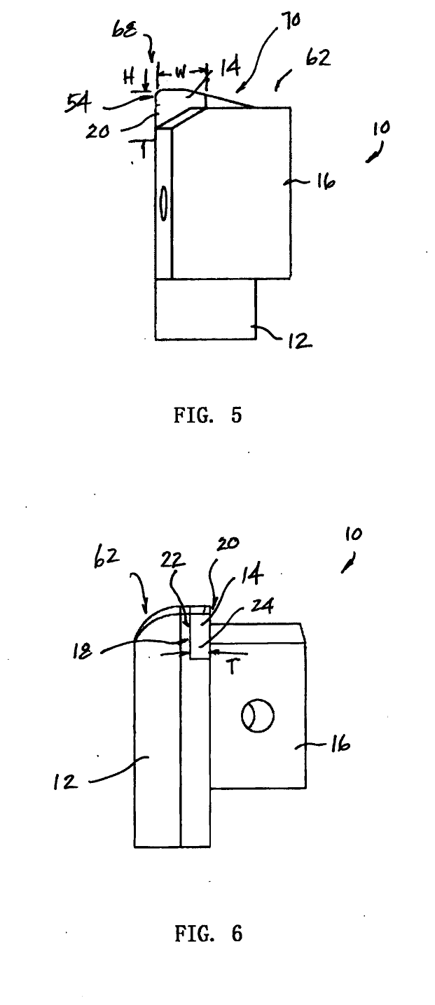

Referring yet again to FIG. 2, in one embodiment, the PCD chip 14 provides a plurality of cutting surfaces that are alternately exposed upon rotation of the PCD chip 14 or repositioning of the PCD chip 14 within the opening 18. In the particular embodiment shown, the PCD chip 14 provides two cutting surfaces, namely a first cutting surface 54 that is generally defined by at least a portion of the first rounded corner 26, such as a first edge 56, and a second cutting surface 58 that is generally defined by at least a portion of the opposing second rounded corner 28, such as a second edge 60. As shown in FIGS. 1 and 5, for example, the first cutting surface 54 is exposed while the second cutting surface 58 is hidden or at least partially covered by the complementary corner surface 52 of the carbide cartridge 12 and the wedge clamp 16. It is contemplated that after the first cutting surface 54 becomes worn, the PCD chip 14 is rotated or repositioned within the opening 18 to expose the second cutting surface 58 and, thus, hide or cover at least a portion of the worn, first cutting surface 54 within the complementary corner surface 52 of the carbide cartridge 12. In another embodiment, the PCD chip 14 has a square shape such that four cutting surfaces are provided at the respective four corners of the PCD chip 14 upon rotation or repositioning of the PCD chip 14 within the opening 18. Other polygonal shapes and/or orientations may be contemplated, such as the orientations having the second flat face 22 abutting the flat wall 50 of the opening 18. As such, the PCD chip 14 is positionable in a plurality of orientations within the opening 18 of the carbide cartridge 12.

With reference to FIG. 2, the opening 18 is defined by a void, hole, slot, or groove, for example, in the carbide cartridge 12. In one embodiment, the opening 18 is defined by the ramped wall 46, the straight wall 48, the flat wall 50, and the corner surface 52 of the carbide cartridge 12. One or more of the surfaces defining the opening 18 is configured to receive more than one orientation of the PCD chip 14 therein to alternately expose different cutting surfaces of the PCD chip 14. Further, it is contemplated that the opening 18 is provided at a periphery of the carbide cartridge 12 as shown in FIGS. 2 and 6, such that the PCD chip 14 may be exposed for cutting.

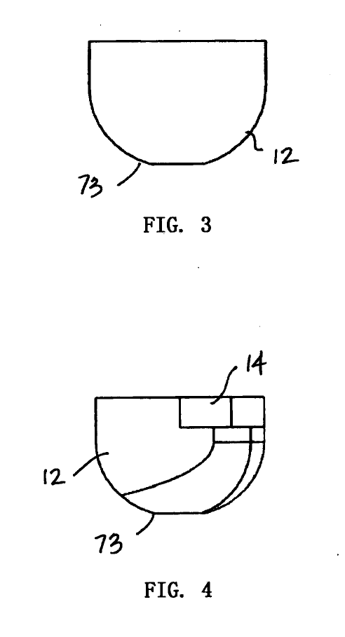

Referring again to FIGS. 1-10, the carbide cartridge 12 may have any shape and/or any size suitable for positioning on the cutter 11. In the particular embodiments shown, the carbide cartridge 12 is generally elongate and rectangular in shape with the opening 18 provided at one end, such as a cutting end 62. The cutting end 62 may further include a rounded edge 64 and a beveled edge 66. It is contemplated that the rounded edge 64 and the beveled edge 66 are similar in geometry to at least some portions of the PCD chip 14, such as the first rounded corner 26 and the first beveled corner 30, respectively, such that when the PCD chip 14 is positioned in the opening 18 as shown in FIGS. 1 and 5, the PCD chip 14 and the carbide cartridge 12 join together in a smooth, seamless-like fashion. In these embodiments, a continuous rounded edge 68 and a continuous beveled edge 70 are rendered by the combination of the PCD chip 14 and the carbide cartridge 12 at the cutting end 62, as shown in FIGS. 1 and 5. As shown, for example, in FIGS. 1 and 2, the carbide cartridge 12 may include additional rounded surfaces, such as a rounded elongate edge 72. In certain embodiments, at least a portion of the carbide cartridge 12 includes a rounded rear surface 73, as shown in FIGS. 3, 4, and 7, that corresponds to a complementary rounded surface defining a recess, cavity or other suitable void formed in the cutter 11 to allow the carbide cartridge 12 to rotate with respect to the cutter 11, as described in greater detail below. Such rotation of the carbide cartridge 12 with respect to the cutter 11 provides for different insert geometries of the cutting tool 10.

Still referring to FIGS. 1 and 2, the carbide cartridge 12 provides a generally smooth and straight panel 74 that is interrupted by the opening 18 toward the cutting end 62 of the carbide cartridge 12. With the PCD chip 14 resting in the opening 18, the panel 74 and one of the first and second flat faces 20, 22 form a smooth, seamless combined surface that abuts a portion of the wedge clamp 16. As shown in FIG. 1, it is contemplated that at least a portion of the panel 74 that is opposite the cutting end 62 of the carbide cartridge 12 is exposed and not in contact with the wedge clamp 16. The panel 74 may further provide attachment means (not shown) that correspond to attachment means provided on the wedge clamp 16 in order to removably secure the wedge clamp 16 to the panel 74. Such attachment means may include, for example, one or more set screws, threaded fasteners, or other suitable means known in the art. In one embodiment, the wedge clamp 16 is threadingly coupled to the carbide cartridge 12. Further, it is noted that numerous alternative embodiments can be contemplated for the reusable cutting tool 10, including a cutting tool 10 providing a plurality of openings 18 and/or securing a plurality of PCD chips 14 in the carbide cartridge 12 and/or the wedge clamp 16.

Referring again to FIGS. 1 and 2, at least a portion of the wedge clamp 16 overlaps at least a portion of the opening 18 when attached to the carbide cartridge 12. In this embodiment, the wedge clamp 16 is removably coupled to the cutter 11 to secure the PCD chip 14 within the opening 18. Further, the wedge clamp 16 is adapted to be at least partially removed or loosened from the cutter 11 to permit repositioning of the PCD chip 14 in the opening 18. It is contemplated that the wedge clamp 16 is configured to secure more than one orientation of the PCD chip 14 in the opening 18. Further, the wedge clamp 16 secures the carbide cartridge 12 to the cutter 11. In one aspect, the wedge clamp 16 is shaped to secure the carbide cartridge 12 within the cutter 11 at one or more of the following insert geometries: a positive insert geometry, a negative insert geometry, or a neutral insert geometry.

Referring additionally to FIGS. 8-10, in the exemplary embodiments, the rounded rear surface 73 of carbide cartridge 12 as shown in FIGS. 3, 4, and 6 compliments a shape of the cutter wall 75 defining a corresponding recess 76 of the cutter 11, shown in FIGS. 8-10, to allow rotation of the carbide cartridge 12 with respect to the cutter 11 with the cutting tool 10 positioned within the corresponding recess 76. In one embodiment, the wedge clamp 16 is at least partially removable or loosened from the cutter 11 to facilitate rotating the cartridge 16 within the corresponding recess 76 defined in the cutter 11 and/or to permit repositioning of the PCD chip 14 in the opening 18.

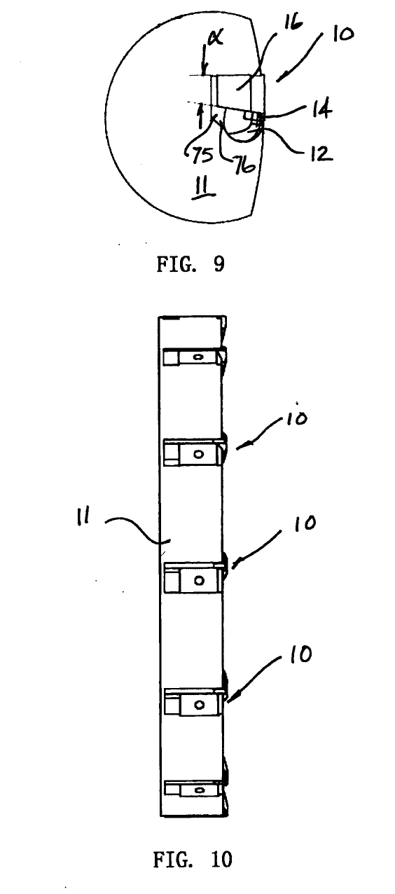

Further, the insert geometry of the cutting tool 10 can be changed by selecting a wedge clamp 16 configured to secure the carbide cartridge 12 within recess 76 of the cutter 11 at the desired insert geometry. In other words, different wedge clamps having different clamp angles can be selected to change the insert geometry of the cutting tool 10. For example, in one embodiment, the wedge clamp 16 as shown in FIG. 9 has a clamp angle, α, of 9.46° to provide a negative insert geometry. In alternative embodiments, the wedge clamp 16 may have any suitable clamp angle greater than or less than 9.46°. As such, a wedge clamp 16 having a first clamp angle is replaceable with a wedge clamp 16 having a second clamp angle different from the first clamp angle. Various securing mechanisms may be used as known in the art. In the present embodiment, the wedge clamp 16 provides a threaded hole 77 that may be adapted to receive a set screw or other attachment mechanism to removably couple the wedge clamp 16 to the cutter 11. Therefore, it is contemplated that the wedge clamp may both removably secure the PCD chip 14 in the opening 18 and removably secure the carbide cartridge 12 to the cutter 11.

In the present embodiment, the wedge clamp 16 is generally cuboid in shape with a beveled edge 78. The beveled edge 78 is positioned adjacent to the opening 18 when the wedge clamp 16 is attached to the carbide cartridge 12 to permit more exposure of cutting surfaces on the PCD chip 14 that is received in the opening 18. It is contemplated that the wedge clamp 16 may further include a chip breaker feature (not shown), such as a plurality of grooves or a serrated edge, which may facilitate breaking long, cut strands of scrap from the workpiece. Such chip breaker features may be included in at least a portion of the beveled edge 78.

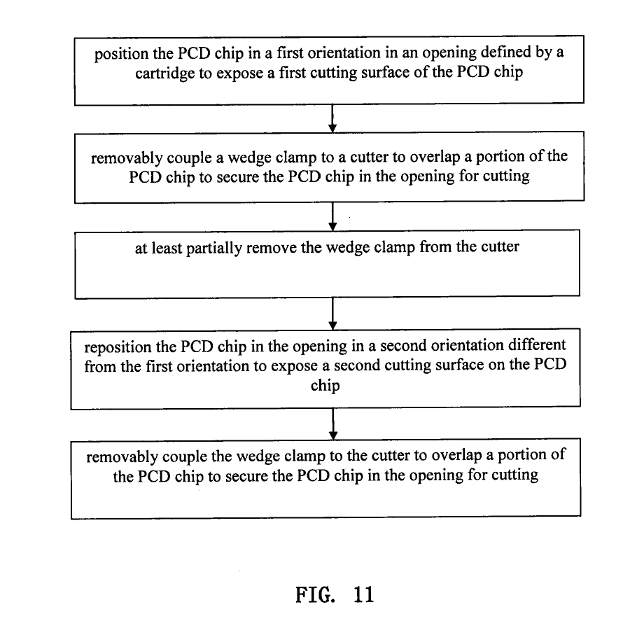

Turning now to FIG. 11, an exemplary method 100 for changing an orientation of a polycrystalline diamond (“PCD”) chip of a reusable diamond tip cutting tool includes positioning 102 the PCD chip 14 in a first orientation at least partially within the opening 18 defined by the carbide cartridge 12 to expose a first cutting surface 54 of the PCD chip 14. As described above, the opening 18 is adapted to removably receive the PCD chip 14. The wedge clamp 16 is removably coupled 104 to the cutter 11 to overlap a portion of the PCD chip to secure the PCD chip in the opening 18 with the first cutting surface 54 exposed for performing cutting operations 106. The wedge clamp 16 is at least partially removed 108 from the cutter 11. The PCD chip 14 is repositioned 110 within the opening 18 in a second orientation different from the first orientation to expose the second cutting surface 58 on the PCD chip 14. The wedge clamp 16 is removably coupled 112 to the cutter 11 to overlap a portion of the PCD chip to secure the PCD chip 14 in the opening 18 with the second cutting surface 58 exposed for subsequent cutting operation 116. In some embodiments, the PCD chip 14 is grinded to a smaller PCD chip. The smaller PCD chip can be secured to a second carbide cartridge that provides a second opening adapted to secure the smaller PCD chip.

The foregoing description of embodiments and examples has been presented for purposes of illustration and description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent devices by those of ordinary skill in the art. Rather, it is hereby intended the scope be defined by the claims appended hereto. Additionally, the features of various implementing embodiments may be combined to form further embodiments. The word “exemplary” is used herein to mean serving as an example, instance, or illustration. Any aspect or embodiment described herein as “exemplary” is not necessarily to be construed as preferred or advantageous over other aspects or embodiment.

What is claimed is:

1. A diamond tip cutting tool adapted to be positioned in a cutter, the diamond tip cutting tool comprising:
a polycrystalline diamond (“PCD”) chip;
a cartridge defining an opening adapted to receive the PCD chip; and
a wedge clamp removably coupled to the cutter to secure the PCD chip in the opening.

2. The diamond tip cutting tool of claim 1, wherein the PCD chip has a plurality of seating surfaces and the opening is complementary in shape with at least one seating surface of the plurality of seating surfaces of the PCD chip.

3. The diamond tip cutting tool of claim 1, wherein at least a portion of the wedge clamp overlaps a portion of the PCD chip when coupled to the cutter.

4. The diamond tip cutting tool of claim 1, wherein the PCD chip is positionable in a plurality of orientations within the opening of the cartridge.

5. The diamond tip cutting tool of claim 1, wherein the PCD chip comprises a plurality of cutting surfaces.

6. The diamond tip cutting tool of claim 5, wherein the plurality of cutting surfaces comprises at least one of an edge and a corner of the PCD chip.

7. The diamond tip cutting tool of claim 1, wherein the opening is configured to receive the PCD chip in a plurality of orientations to alternately expose different cutting surfaces of the PCD chip.

8. The diamond tip cutting tool of claim 1, wherein the wedge clamp has a first clamp angle and is replaceable with a second wedge clamp having a second clamp angle different from the first clamp angle.

9. The diamond tip cutting tool of claim 1, wherein the wedge clamp secures the cartridge within a corresponding recess defined in the cutter.

10. The diamond tip cutting tool of claim 1, wherein the wedge clamp is removable from the cutter to facilitate rotating the cartridge within a corresponding recess defined in the cutter.

11. The diamond tip cutting tool of claim 1, wherein the wedge clamp is at least partially removable from the cutter to permit repositioning of the PCD chip in the opening.

12. The diamond tip cutting tool of claim 1, wherein the wedge clamp is configured to secure the PCD chip in the opening of the cartridge in a plurality of orientations.

13. The diamond tip cutting tool of claim 1, further comprising a chip breaker disposed on a portion of the wedge clamp to facilitate breaking up cut strands.

14. A reusable diamond tip cutting tool adapted to be positioned in a cutter, the reusable diamond tip cutting tool comprising:
a polycrystalline diamond (“PCD”) chip;
a cartridge removably positionable within a recess defined in the cutter, the cartridge defining an opening adapted to receive the PCD chip, wherein the opening is cut into an outer edge of the cartridge and complementary in shape to the PCD chip; and
a wedge clamp removably coupled to the cutter adjacent to the opening to overlap a portion of the opening, wherein the wedge clamp removably secures the PCD chip in the opening and removably secures the cartridge to the cutter.

15. The diamond tip cutting tool of claim 14, wherein the PCD chip comprises a plurality of seating surfaces that are complementary in shape with the opening.

16. The diamond tip cutting tool of claim 14, wherein the wedge clamp secures the cartridge within a corresponding recess defined in the cutter.

17. The diamond tip cutting tool of claim 14, wherein the wedge clamp is replaceable with a second wedge clamp to secure the cartridge within the cutter at one of the following insert geometries: a positive insert geometry, a negative insert geometry, or a neutral insert geometry.

18. The diamond tip cutting tool of claim 14, wherein at least a portion of the cartridge comprises a rounded surface that corresponds to a complementary rounded surface on the cutter defining the recess to allow the cartridge to rotate with respect to the cutter.

19. A method for changing an orientation of a polycrystalline diamond (“PCD”) chip of a reusable diamond tip cutting tool, the method comprising:
positioning the PCD chip in a first orientation in an opening defined by a cartridge to expose a first cutting surface of the PCD chip;
removably coupling a wedge clamp to a cutter to overlap a portion of the PCD chip to secure the PCD chip in the opening for cutting;
at least partially removing the wedge clamp from the cutter;
repositioning the PCD chip in the opening in a second orientation different from the first orientation to expose a second cutting surface on the PCD chip; and
removably coupling the wedge clamp to the cutter to overlap a portion of the PCD chip to secure the PCD chip in the opening for cutting.

20. The method of claim 19, further comprising grinding the PCD chip to a smaller PCD chip and securing the smaller PCD chip to a second cartridge, wherein the second cartridge provides a second opening adapted to secure the smaller PCD chip.
